(19) United States
(12) Patent Application Publication
(10) Pub. No.: US 2009/0135160 A1
(43) Pub. Date: May 28, 2009

(54) CAPACITIVE TYPE TOUCH PANEL

(75) Inventor: Jeng-Hung Sun, Hsinchu City (TW)

Correspondence Address: MERCHANT & GOULD PC, P.O. BOX 2903, MINNEAPOLIS, MN, 55402-0903, US

(73) Assignee: ACROSENSE TECHNOLOGY CO., LTD., Annan District (TW)

(21) Appl. No.: 12/275,784

(22) Filed: Nov. 21, 2008

(30) Foreign Application Priority Data
Nov. 23, 2007 (TW) 096144536

(51) Int. Cl. G06F 3/045

(52) U.S. Cl. 345/174

(57) ABSTRACT

A capacitive type touch panel includes: a transparent substrate; and a transparent touch control unit disposed on the substrate and including a plurality of spaced apart transparent key pads that are made from a transparent electrically conductive material, and a transparent electrically conductive reference potential member that is associated operatively and electrically with the transparent key pads to generate a charge distribution between two adjacent ones of the transparent key pads, thereby forming virtual key pads among the transparent key pads.

### CROSS-REFERENCE TO RELATED APPLICATION

This application claims priority of Taiwanese Application No. 096144536, filed on Nov. 23, 2007.

### BACKGROUND OF THE INVENTION

1. Field of the Invention

This invention relates to a capacitive type touch panel, more particularly to a capacitive type touch panel including transparent key pads and a reference potential member associated operatively and electrically with the transparent key pads to form virtual key pads thereamong.

2. Description of the Related Art

Conventional electronic devices, such as an MP4 or PMP player, a digital camera, or a cellular phone, normally include a touch panel and key pads installed on a housing. The key pads are separated from the touch panel and are provided with printed plastic caps thereon. The demand for a large touch screen on the electronic device is increasing. However, the key pads are opaque and occupy a relatively large portion of a front cover of the housing, which limits the size of the touch panel. In addition, the number of the key pads is relatively few, which limits the number of commands or icons that can be provided on each command level of a menu shown on the screen. Hence, there is a need to enlarge the size of the touch panel and the number of the key pads on the touch panel.

### SUMMARY OF THE INVENTION

Therefore, an object of the present invention is to provide a capacitive type touch panel having a pattern of transparent key pads and a reference potential member operatively and electrically associated with the transparent key pads to form virtual key pads thereamong so as to increase the size of the touch panel and the number of key pads on an electronic device.

According to this invention, there is provided a capacitive type touch panel that comprises: a transparent substrate; and a transparent touch control unit disposed on the substrate and including a plurality of spaced apart transparent key pads that are made from a transparent electrically conductive material, and a transparent electrically conductive reference potential member that is associated operatively and electrically with the transparent key pads to generate a charge distribution between two adjacent ones of the transparent key pads, thereby forming virtual key pads among the transparent key pads such that each of the transparent key pads and the virtual key pads is operable to sense an object when the object approaches closely the respective one of the transparent key pads and the virtual key pads.

### BRIEF DESCRIPTION OF THE DRAWING

Other features and advantages of the present invention will become apparent in the following detailed description of the preferred embodiments of this invention, with reference to the accompanying drawings, in which:

FIG. 1 is an exploded perspective view of the first preferred embodiment of a capacitive type touch panel for a touch panel device according to this invention;

FIG. 2 is a schematic top view of the first preferred embodiment;

FIG. 3 is a fragmentary sectional view of the first preferred embodiment taken from lines III-III of FIG. 2;

FIG. 4 is a fragmentary sectional view of the second preferred embodiment of the capacitive type touch panel according to this invention; and

FIG. 5 is a fragmentary sectional view of the third preferred embodiment of the capacitive type touch panel according to this invention.

### DETAILED DESCRIPTION OF THE PREFERRED EMBODIMENTS

Before the present invention is described in greater detail with reference to the accompanying preferred embodiments, it should be noted herein that like elements are denoted by the same reference numerals throughout the disclosure.

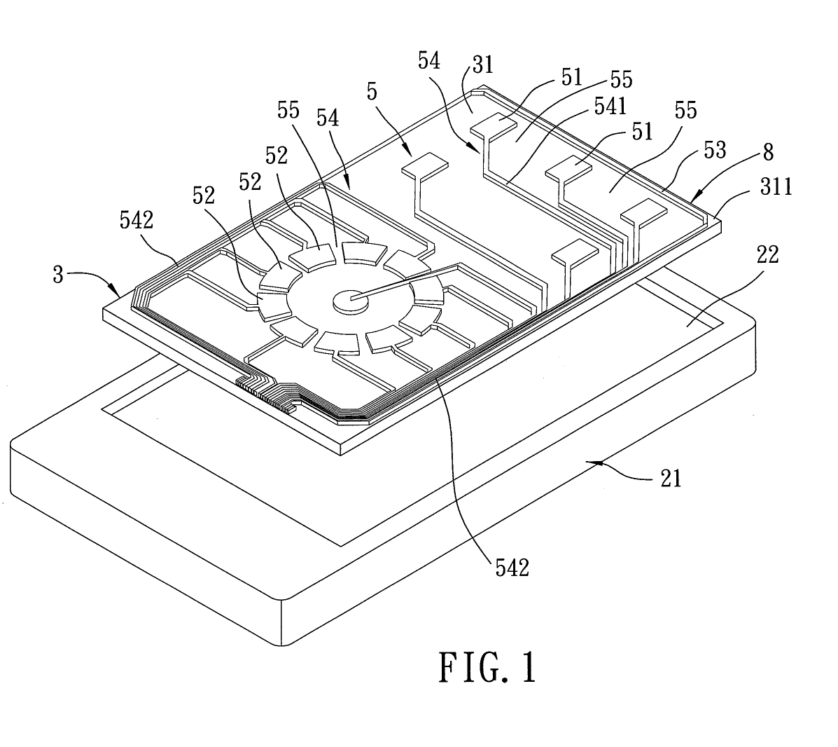

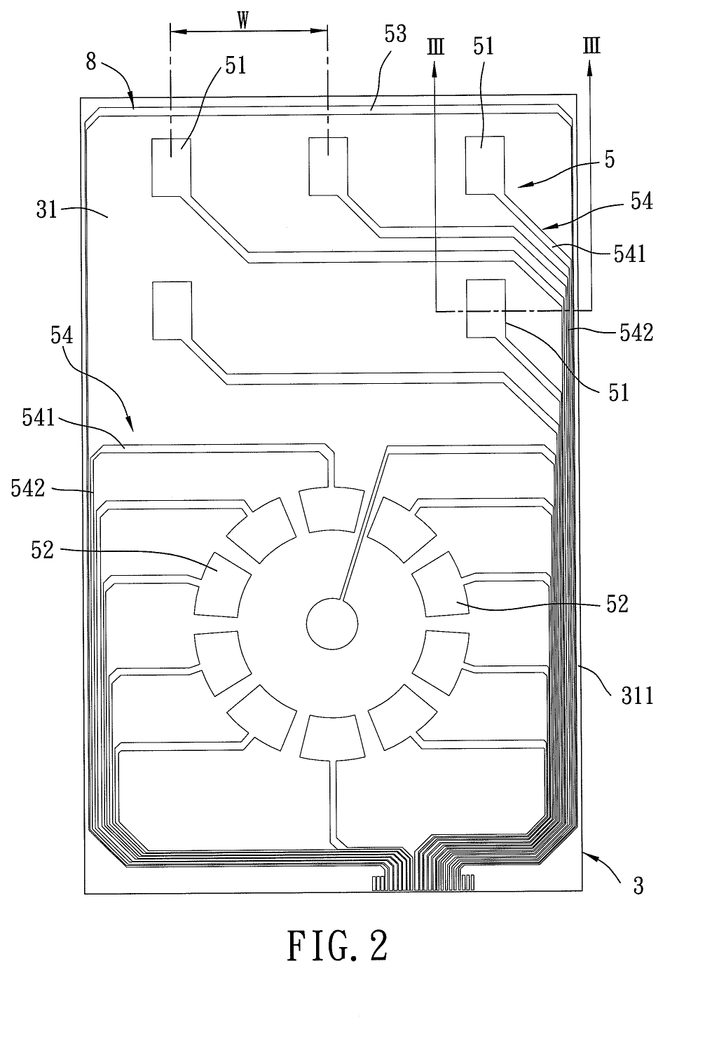

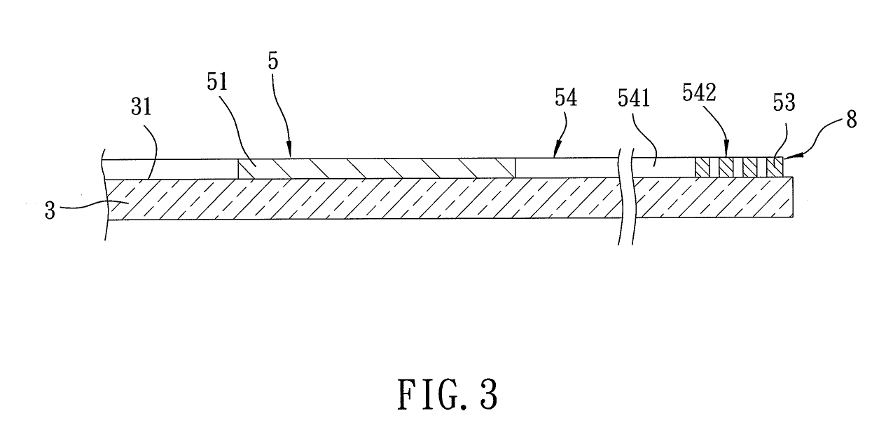

FIGS. 1 to 3 illustrate the first preferred embodiment of a capacitive type touch panel according to this invention. The capacitive type touch panel is adapted to be superposed on a screen 22 of a touch panel device 21, and includes: a transparent substrate 3; and a transparent touch control unit 5 including a plurality of spaced apart transparent first and second key pads 51, 52 that are disposed on the substrate 3 and that are made from a transparent electrically conductive material, and a transparent electrically conductive reference potential member 8 that is associated operatively and electrically with the transparent first and second key pads 51, 52 to generate a charge distribution between two adjacent ones of the transparent first and second key pads 51, 52, thereby forming position independent virtual key pads 55 among the transparent first and second key pads 51, 52 such that each of the transparent first and second key pads 51, 52 and the virtual key pads 55 is operable to sense an object (not shown) when the object approaches closely the respective one of the transparent first and second key pads 51, 52 and the virtual key pads 55. The reference potential member 8 can be disposed on one of the screen 22 and the substrate 3 or therebetween.

The relative positions among the reference potential member 8 and the first and second keypads 51, 52 are adjusted to permit formation of the virtual keypads 55, i.e., there exists a continuous charge distribution between two adjacent ones of the first and second key pads 51, 52, that can be utilized as real touch keys for performing commands or icons shown on locations of the screen 22 corresponding to said two adjacent ones of the first and second key pads 51, 52.

In this embodiment, the transparent substrate 3 has a mounting surface 31. The transparent first and second key pads 51, 52 are formed on the mounting surface 31 of the substrate 3. Each two adjacent ones of the transparent first and second key pads 51, 52 are spaced apart from each other by a pitch (W) (center-to-center) preferably not greater than 15 mm for achieving a high-resolution key pad.

In this embodiment, the reference potential member 8 is spaced apart from each of the transparent first and second key pads 51, 52 by a distance sufficient for generating a continuous charge distribution among the first key pads 51 and among the second key pads 52.

In this embodiment, the transparent first and second key pads 51, 52 are formed on the mounting surface 31 of the substrate 3. The mounting surface 31 of the substrate 3 has a peripheral edge 311, and is formed with a transparent conductive strip 53 that extends along the peripheral edge 311 of the mounting surface 31 to surround the transparent first and second key pads 51, 52 and that defines the reference potential member 8.

The substrate 3 may be made from materials, such as glass, polymethylmethacrylate (PMMA), polyvinylchloride (PVC), polypropylene (PP), polyethylene terephthalate (PET), polyethylene naphthalate (PEN), and polycarbonate (PC).

The touch control unit 5 further includes a plurality of transparent conductive connecting lines 54, each of which has a first section 541 extending from a respective one of the transparent first and second key pads 51, 52 toward the peripheral edge 311 of the substrate 3, and a second section 542 disposed adjacent to the peripheral edge 311 of the substrate 3 and extending along the peripheral edge 311 of the substrate 3 from the first section 541 for external connection to a controller (not shown).

Preferably, the transparent first and second key pads 51, 52 and the reference potential member 8 are made from a transparent non-metallic material, such as indium-tin-oxide (ITO), indium-zinc-oxide (IZO), aluminum zinc oxide (AZO), and combinations thereof. In some preferred embodiments, the reference potential member 8 and the second section 542 of the connecting lines 54 are made from metal.

In this embodiment, the first keypads 51 are arranged into parallel rows, while the second key pads 52 are angularly displaced from each other so as to perform a desired function, such as increasing gradually the volume of the electronic device 21 when the user's finger slides along a circular path (not shown) on the screen 22 that is superposed over the second key pads 52.

In operation, when the user touches or approaches an icon or a command sign shown on the screen 22 that corresponds to one of the first and second key pads 51, 52 and the virtual keypads 55, the charge difference between the reference potential member 8 and the respective one of the first and second key pads 51, 52 and the virtue key pads 55 is changed, thereby enabling control of the electronic device 21 to perform the function corresponding to the touched icon or command.

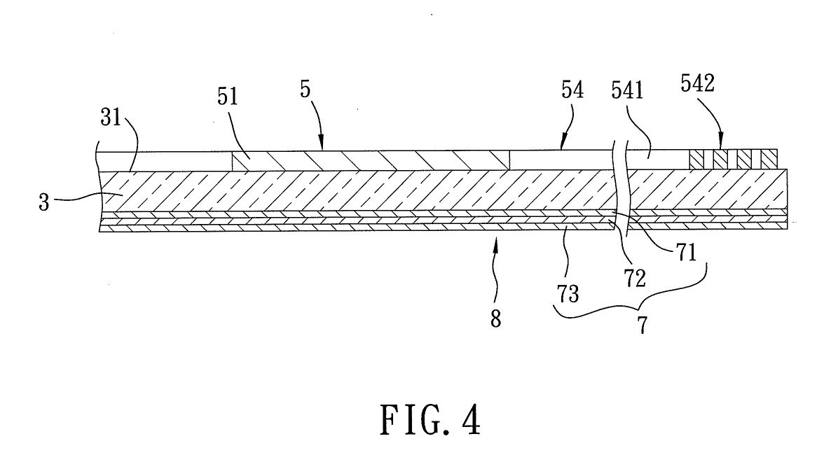

FIG. 4 illustrates the second preferred embodiment of the capacitive type touch panel according to this invention. The second preferred embodiment differs from the previous embodiment in that the reference potential member 8 is in the form of an electrically conductive thin layer 7 formed on an opposite surface of the substrate 3 opposite to the mounting surface 31 and having an area covering the transparent first and second key pads 51, 52. Note that the substrate 3 has a layer thickness preferably greater than 0.06 mm and smaller than 4 mm so as to achieve a low charge ratio between the touch panel and the object touching thereon and so as to achieve a continuous charge distribution among the first and second key pads 51, 52.

The conductive thin layer 7 includes a transparent inner film 71 of a transparent material bonded to the opposite surface of the substrate 3, a transparent middle film 72 of a metal bonded to the inner film 71, and a transparent outer film 73 bonded to the middle film 72 for protecting the metal film 72 from scratching and humid environment. The inner film 71 and the protecting film 73 may be made from a transparent conductive or non-conductive material. In this embodiment, the inner film 71 and the outer film 73 are made from a transparent electrically conductive material, such as indium-tin-oxide (ITO), indium-zinc-oxide (IZO), aluminum zinc oxide (AZO), and combinations thereof. The middle film 72 is preferably made from silver or silver alloy, and has a film thickness of about 10 nm.

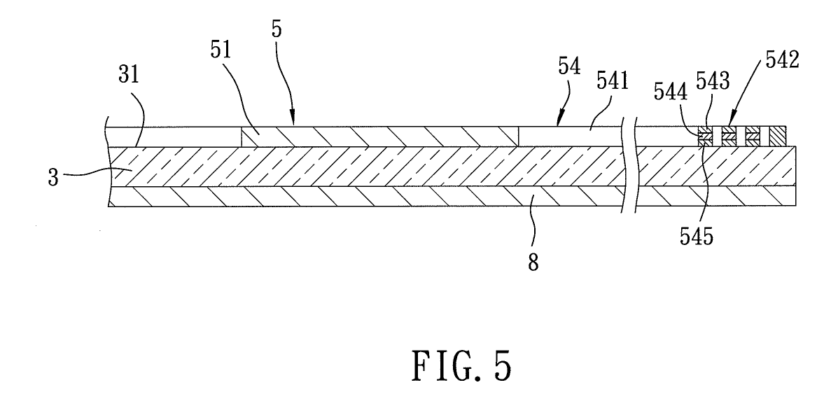

FIG. 5 illustrates the third preferred embodiment of the capacitive type touch panel according to this invention. The third preferred embodiment differs from the second preferred embodiment in that the first section 541 of each of the connecting lines 54 is made from a transparent non-metallic electrically conductive material, and the second section 542 of each of the connecting lines 54 includes upper and lower films 543, 545 of a transparent electrically conductive material and a middle film 544 of metal disposed between the upper and lower films 543, 545. The tri-layer structure of the second section 542 of each of the connecting lines 54 permits reduction of the electrical resistance of each of the connecting lines 54.

In this embodiment, the conductive thin layer 7 is made from a transparent electrically conductive material, such as indium-tin-oxide (ITO), indium-zinc-oxide (IZO), aluminum zinc oxide (AZO), and combinations thereof.

By forming the transparent first and second key pads 51, 52 on the mounting surface 31 of the substrate and with the inclusion of the reference potential member 8 in the touch control unit 5 of the capacitive type touch panel of this invention, formation of the virtual key pads 55 on the capacitive type touch panel is feasible and a high-resolution key pad can be achieved.

While the present invention has been described in connection with what are considered the most practical and preferred embodiments, it is understood that this invention is not limited to the disclosed embodiments but is intended to cover various arrangements included within the spirit and scope of the broadest interpretation and equivalent arrangements.

What is claimed is:

1. A capacitive type touch panel comprising:
a transparent substrate; and
a transparent touch control unit disposed on said substrate and including a plurality of spaced apart transparent key pads that are made from a transparent electrically conductive material, and a transparent electrically conductive reference potential member that is associated operatively and electrically with said transparent key pads to generate a charge distribution between two adjacent ones of said transparent key pads, thereby forming virtual key pads among said transparent key pads such that each of said transparent key pads and said virtual key pads is operable to sense an object when the object approaches closely the respective one of said transparent key pads and said virtual key pads.

2. The capacitive type touch panel of claim 1, wherein said transparent substrate has a mounting surface, said transparent key pads being formed on said mounting surface of said substrate, said mounting surface of said substrate having a peripheral edge and being formed with a transparent conductive strip that extends along said peripheral edge of said mounting surface to surround said transparent key pads and that defines said reference potential member.

3. The capacitive type touch panel of claim 2, wherein said touch control unit further includes a plurality of transparent conductive connecting lines, each of which has a first section extending from a respective one of said transparent key pads toward said peripheral edge of said substrate, and a second section disposed adjacent to said peripheral edge of said substrate and extending along said peripheral edge of said substrate from said first section.

4. The capacitive type touch panel of claim 3, wherein said first section of each of said connecting lines is made from a transparent non-metallic electrically conductive material, said second section of each of said connecting lines including upper and lower films of a transparent electrically conductive material and a middle film of metal disposed between said upper and lower films.

5. The capacitive type touch panel of claim 3, wherein said first section of each of said connecting lines is made from a transparent non-metallic electrically conductive material, said second section of each of said connecting lines being made from metal.

6. The capacitive type touch panel of claim 3, wherein said first and second sections of each of said connecting lines is made from a transparent non-metallic electrically conductive material.

7. The capacitive type touch panel of claim 1, wherein said transparent substrate has a mounting surface, said transparent key pads being formed on said mounting surface of said substrate, said reference potential member being in the form of an electrically conductive thin layer formed on an opposite surface of said substrate opposite to said mounting surface.

8. The capacitive type touch panel of claim 7, wherein said reference potential member includes a transparent inner film of a transparent material bonded to said opposite surface of said substrate, and a transparent middle film of a metal bonded to said inner film.

9. The capacitive type touch panel of claim 8, wherein said reference potential member further includes a transparent outer film bonded to said middle film.

10. The capacitive type touch panel of claim 1, wherein said transparent key pads are arranged into parallel rows.

11. The capacitive type touch panel of claim 1, wherein said transparent key pads are angularly displaced from each other.

12. A touch panel device comprising:
a screen;
a transparent substrate superposed on said screen; and
a transparent touch control unit including a plurality of spaced apart transparent key pads that are made from a transparent electrically conductive material and that are formed on said substrate, and a transparent conductive reference potential member that is disposed on one of said screen and said substrate and that is associated operatively and electrically with said transparent key pads to generate a charge distribution between two adjacent ones of said transparent key pads, thereby forming virtual key pads among said transparent key pads such that each of said transparent key pads and said virtual key pads is operable to sense an object when the object approaches closely the respective one of said transparent key pads and said virtual key pads.

13. The touch panel device of claim 12, wherein said transparent substrate has a mounting surface, said transparent key pads being formed on said mounting surface of said substrate, said mounting surface of said substrate having a peripheral edge and being formed with a transparent conductive strip that extends along said peripheral edge of said mounting surface to surround said transparent key pads and that defines said reference potential member.

14. The touch panel device of claim 12, wherein said transparent substrate has a mounting surface, said transparent key pads being formed on said mounting surface of said substrate, said reference potential member being in the form of an electrically conductive thin layer formed on an opposite surface of said substrate opposite to said mounting surface and having an area covering said transparent key pads.
